(19) United States
(12) Patent Application Publication
(10) Pub. No.: US 2003/0204569 A1
(43) Pub. Date: Oct. 30, 2003

(54) Method and apparatus for filtering e-mail infected with a previously unidentified computer virus

(76) Inventors: Michael R. Andrews, Berkeley Heights, NJ (US); Gregory P. Kochanski, Dunellen, NJ (US); Daniel Philip Lopresti, Hopewell, NJ (US); Chi-Lin Shih, Berkeley Heights, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/135,102

(22) Filed: Apr. 29, 2002

(51) Int. Cl. G06F 13/14; G06F 15/16; G06F 12/14; G06F 11/30; H04L 9/32; H04L 9/00

(52) U.S. Cl. 709/206; 713/201

(57) ABSTRACT

E-mail which may be infected by a computer virus is advantageously filtered by incorporating a “Reverse Turing Test” to verify that the source of a potentially infected e-mail is human and not a machine, and that the message was intentionally transmitted by the apparent sender. Such a test may, for example, involve asking a question which will be easy for a human to answer correctly but quite difficult for a machine to do so. The e-mail may be deemed to be potentially infected based on an analysis of executable code which is attached to the e-mail, or merely based on the fact that executable code is attached. The e-mail may also be deemed to be potentially infected based on additional factors, such as, for example, the identity of the sender and past experiences therewith. Spam E-mail may also be advantageously filtered together with virus-containing e-mail with use of a single common filtering system.

### FIELD OF THE INVENTION

The present invention relates generally to the filtering of undesirable e-mail (i.e., electronic mail) and more particularly to a method and apparatus for filtering out e-mail which may be infected by an unknown, previously unidentified computer virus.

### BACKGROUND OF THE INVENTION

Over the past ten years, e-mail has become a vital communications medium. Once limited to specialists with technical backgrounds, its use has rapidly spread to ordinary consumers. E-mail now provides serious competition for all other forms of written and electronic communication. Unfortunately, as its popularity has grown, so has its abuses. Two of the most significant problems are unsolicited commercial e-mail (also known as “spam”) and computer viruses that propagate via e-mail. For example, it has been reported that the annual cost of spam to a large ISP (Internet Service Provider) is $7.7 million per million users. And it has been determined that computer viruses cost companies worldwide well over $10 billion in 2001.

With regard to spam e-mail, note that there is little natural incentive for a mass e-mailer to minimize the size of a mailing list, since the price of sending an e-mail message is negligible. Rather, spammers attempt to reach the largest possible group of recipients in the hopes that a bigger mailing will yield more potential customers. The fact that the vast majority of those receiving the message will have no interest whatsoever in what is being offered and regard the communication as an annoyance is usually not a concern. It has been reported that it is possible to purchase mailing lists that purport to supply 20 million e-mail addresses for as little as $150.

Computer viruses, on the other hand, are the other and much more insidious example of deleterious e-mail. One important difference between spam and viruses, however, is that viruses in some cases appear to originate from senders the user knows and trusts. In fact, the most common mechanism used to “infect” computers across a network is to attach the executable code for a virus to an e-mail message. Then, when the e-mail in question is opened, the virus accesses the information contained in the user's address book and mails a copy of itself to all of the user's associates. Since such messages may seem to come from a reliable source, the likelihood the infection will be spread by unwitting recipients is greatly increased. While less prevalent in number than spam, viruses are generally far more disruptive and costly. These two e-mail related problems—spam and viruses—have heretofore been treated as two separate and distinct problems, requiring separate and distinct solutions.

Present solutions to the virus problem usually focus on an analysis of the executable code which is attached to the e-mail message. In particular, current virus detection utilities typically maintain a list of signatures of known, previously detected viruses. Then, when an incoming e-mail with attached executable code is received, they compare these previously identified signatures to the executable code. If a match is found, the e-mail is tagged as infected and is filtered out. Unfortunately, although this approach works well for known virus, it is essentially useless against new, previously undetected and unknown viruses.

For protection against such new (previously undetected) viruses, it has been suggested that machine learning techniques may be used in an attempt to classify strings of byte patterns as potentially deriving from a virus. Then such classified patterns will be filtered in the same manner as if they were a signature of a known virus. However, such techniques will necessarily only succeed in accurately identifying a virus part of the time, and such a failure means that in some cases viruses will get through (if the filter is too porous), that legitimate messages will get stopped (if the filter is too fine), or both.

### SUMMARY OF THE INVENTION

In accordance with the principles of the present invention, electronic mail (i.e., e-mail) which may be infected by a previously unidentified computer virus is advantageously filtered by incorporating a “Reverse Turing Test” (also known as a “Human Interactive Proof”) to verify that the source of the potentially infected e-mail is a human and not a machine, and that the message was intentionally transmitted by the apparent sender. (As used herein, the term “virus” is intended to include computer viruses, computer worms, and any other computer program or piece of computer code that is loaded onto a computer without one's knowledge and runs against one's wishes. Also as used herein, the terms “electronic mail” and “electronic mail message” are intended to include any and all forms of electronic communications which may be received by a computer.) A “Reverse Turing Test” is an interaction by a first party (which may be a machine) with a second party, designed to determine and inform the first party whether the second party is a human being or an automated (machine) process. Typically, such a test involves either asking a question or requesting that a task be performed, which will be easy for a human to answer or perform correctly but quite difficult for a machine to do so.

In accordance with various illustrative embodiments of the present invention, the e-mail may be deemed to be potentially infected (and thus should be verified with use of the Reverse Turing Test) based, at least in part, on an analysis of executable code which is attached to the e-mail, or merely based on the fact that some executable code is attached. And in accordance with certain illustrative embodiments of the present invention, the e-mail may be deemed to be potentially infected also based on other factors, such as, for example, the identity of the sender and past experiences therewith.

More particularly, and in accordance with the present invention, a method (and a corresponding apparatus) is provided for automatically filtering electronic mail, the method (for example) comprising the steps of receiving an original electronic mail message from a sender; identifying the original electronic mail message as being potentially infected with a computer virus; and automatically sending a challenge back to the sender, wherein the challenge comprises an electronic mail message which requests a response from the sender, and wherein the challenge has been designed to be answered by a person and not by a machine.

### BRIEF DESCRIPTION OF THE DRAWINGS

FIG. 1 shows an illustrative filter for filtering out virus infected e-mail and which has been integrated into an existing protocol for processing a user's incoming e-mail in accordance with an illustrative embodiment of the present invention.

FIG. 2 shows an illustrative example of a visual Reverse Turing Test employing synthetic bit-flip noise and the operation of an illustrative OCR (Optical Character Recognition) system.

FIG. 3 shows an overview of an e-mail filtering system in accordance with an illustrative embodiment of the present invention.

FIG. 4 shows details of the analysis portion of the illustrative e-mail filtering system of FIG. 3, whereby an incoming e-mail is analyzed to determine whether it is desirable to issue a challenge to the sender.

FIG. 5 shows details of the challenge portion of the illustrative e-mail filtering system of FIG. 3, whereby a challenge is generated in one of several possible different modalities for issuance to the sender of an incoming e-mail.

FIG. 6 shows details of the post-processing portion of the illustrative e-mail filtering system of FIG. 3, whereby a final decision is made regarding the incoming e-mail based on a response or lack thereof to the issued challenge.

### DETAILED DESCRIPTION

Reverse Turing Tests and Their Use in Illustrative Embodiments of the Invention

The notion of an automatic method (i.e., an algorithm) for determining whether a given entity is either human or machine has come to be known as a “Reverse Turing Test” or a “Human Interactive Proof.” In a seminal work, fully familiar to those skilled in the computer arts, the well known mathematician Alan Turing proposed a simple “test” for deciding whether a machine possesses intelligence. Such a test is administered by a human who sits at a terminal in one room, through which it is possible to communicate with another human in second room and a computer in a third. If the giver of the test cannot reliably distinguish between the two, the machine is said to have passed the “Turing Test” and, by hypothesis, is declared “intelligent.”

Unlike a traditional Turing Test, however, a Reverse Turing Test is typically administered by a computer, not a human. The goal is to develop algorithms able to distinguish humans from machines with high reliability. For a Reverse Turing Test to be effective, nearly all human users should be able to pass it with ease, but even the most state-of-the-art machines should find it very difficult, if not impossible. (Of course, such an assessment is always relative to a given time frame, since the capabilities of computers are constantly increasing. Ideally, the test should remain difficult for a machine for a reasonable period of time despite concerted efforts to defeat it.)

Typically, spam e-mail has been filtered (if at all) based primarily on the identity of the sender and/or the content of the text message in the e-mail. Recently, however, more sophisticated approaches to filtering spam e-mail have been suggested, including those which employ a Reverse Turing Test. For example, U.S. Pat. No. 6,199,102, “Method and System for Filtering Electronic Messages,” issued to C. Cobb on Mar. 6, 2001, discloses an approach to the filtering of unsolicited commercial messages (i.e., spam) by sending a “challenge” back to the sender of the original message, where the “challenge” is a question which can be answered by a person but typically not by a computer system. Similarly, U.S. Pat. No. 6,112,227, “Filter-in Method for Reducing Junk E-mail,” issued to J. Heiner on Aug. 29, 2000, discloses an approach to the filtering of unwanted electronic mail messages (i.e., spam) by requiring the sender to complete a “registration process” which preferably includes “instructions or a question that only a human can follow or answer, respectively.” And in U.S. Pat. No. 6,195,698, “Method for Selectively Restricting Access to Computer Systems,” issued to M. Lillibridge et al. on Feb. 27, 2001, a Reverse Turing Test is employed to restrict access to a computer system—that is, a “riddle” which is difficult for an automated agent (but easy for a human) to answer correctly is provided—and it is briefly pointed out therein that such an approach can also be used to stop spam via e-mail. U.S. Pat. No. 6,199,102, U.S. Pat. No. 6,112,227, and U.S. Pat. No. 6,195,698 are each hereby incorporated by reference as if fully set forth herein.

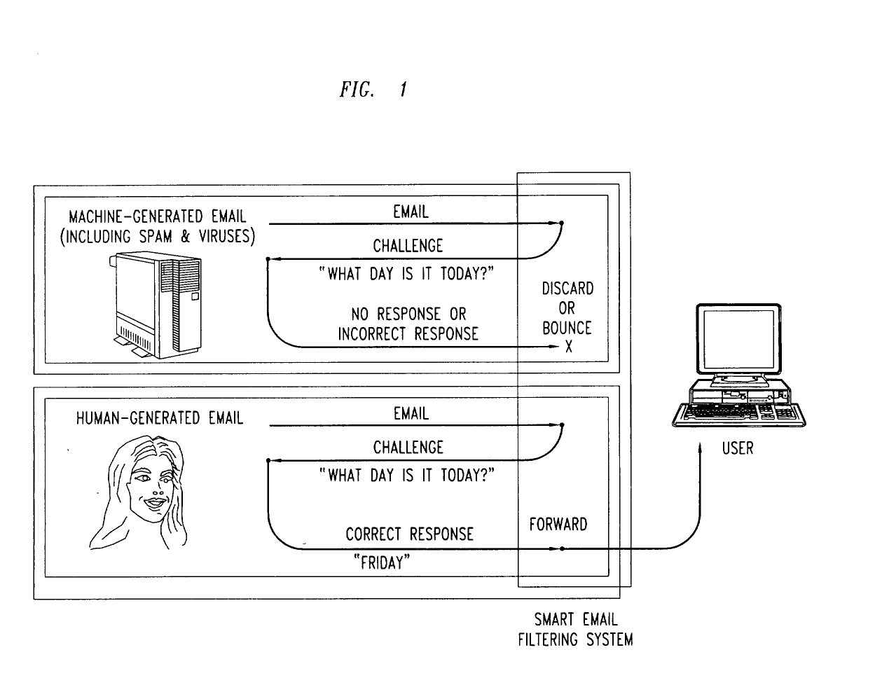

As such, and in accordance with an illustrative embodiment of the present invention, an e-mail filter may be integrated into the existing protocol for processing a user's incoming e-mail, as depicted in FIG. 1. Under certain circumstances the e-mail is deemed to be potentially infected with a virus (see discussion below). The receipt of such a potentially infected e-mail message will result in a challenge being generated and issued to the sender (i.e., a Reverse Turing Test is performed). If the sender does not respond, or responds incorrectly, then the e-mail is not delivered to the user. Only a correct answer to the challenge will result in the message being forwarded to the user.

Because the examiner in a traditional Turing Test is human, it is possible to imagine all manner of sophisticated dialog strategies intended to confound the machine. Spontaneous questions such as “What was the weather yesterday?” are easy for humans to answer, but still difficult for computers. Such techniques do not carry over to the machine-performed Reverse Turing Test, however. First, the examining algorithm must be able to produce a large number of distinct queries. If it were to work from a small list, it would be too easy for an adversary to collect the questions, store the answers in a database, and then use this information to pass the Reverse Turing Test. Second, even assuming a large supply of questions, a machine would have enormous difficulty verifying the responses that were returned. Thus, it is advantageous for the Reverse Turing Test to take a very different approach—one in which the questions are easy to generate and the answers are easy to check automatically, and one that exhibits enough variation to fool machines but not humans.

While e-mail is normally thought of as a textual communications medium, its use for delivering multimedia content is growing rapidly. It is now common for people to share photographs and music files as attachments, for example. Hence, it is not necessary to limit Reverse Turing Tests using text-based challenges and responses. Since certain recognition problems involving non-text media (e.g., speech, and images) are known to be difficult for computers, this fact can be advantageously exploited when deciding on a strategy for distinguishing human users from machines. Likewise, there may be benefits in accepting answers that are, for example, spoken rather than typed, although this will admittedly require that the system includes ASR (Automatic Speech Recognition) capability.

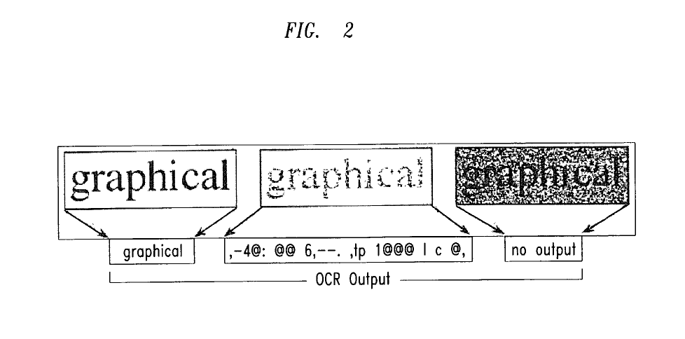

One such type of Reverse Turing Test that has been employed is taken from the field of vision, and is based on the observation that current optical character recognition (OCR) systems are not as adept at reading degraded word images as humans are. As illustrated in FIG. 2, for example, synthetic bit-flip noise can be used in a visual Reverse Turing Test to yield text that is legible to a human reader but problematic for a typical illustrative OCR system. The original image shown on the left of the figure, is illustratively a 16-point Times font at 300 dpi (dots per inch). The sample lightened word image, shown next, is the original image with a 50% bit-flip noise of black to white applied thereto. In this case, the illustrative OCR system produces gibberish, as shown. The sample darkened word image, shown on the right of the figure, is the original image with a 50% bit-flip noise of white to black applied thereto. In this case, the illustrative OCR system produces no output whatsoever, also as shown. Human readers, on the other hand, will have no problem whatsoever in reading either of the degraded images. Despite decades of research, it seems highly unlikely anyone will be able to build an OCR system robust enough to handle all possible degradations anytime soon. With a large dictionary, a library of differing font styles, and a variety of synthetic noise models, a nearly endless supply of word images can be generated.

Similar approaches have been suggested in the field of audio (e.g., speech). While most uses of the web today involve graphical interfaces amenable to the visual approach described above, speech interfaces are proliferating rapidly. And because of their inherent ease-of-use, speech interfaces may someday compete with traditional screen-based paradigms in terms of importance, particularly in the area of wireless communications (e.g., cell phones, which typically have a limited screen size and resolution, but are now frequently capable of sending and receiving e-mail).

Moreover, it has been determined that acoustically degraded speech (e.g., with use of additive noise) may also be quite difficult for recognition by a machine (i.e., an Automatic Speech Recognition system), but fairly easy for a human. In addition to acoustically degrading speech by adding acoustic noise, speech may be advantageously degraded by filtering the speech signal, by removing selected segments of the speech signal and replacing the missing segments with white noise (e.g., replacing 30 milliseconds of the speech signal every 100 milliseconds with white noise), by adding strong “echoes” to the speech signal, or by performing various mathematical transformations on the speech signal (such as, for example, “cubing” it, as in f(t)=F(t)³, where F(t) is the original speech signal and f(t) is the degraded speech signal). In this way, similar success to that which may be found with Reverse Turing Tests in the visual realm may be found in the realm of speech.

And, in addition, text-based questions, which by their nature require natural language understanding to be correctly answered, may also be used as the basis of a Reverse Turing Test. This relatively simple approach works as a result of the fact that machine understanding of natural language is an extremely difficult task.

Note that the Reverse Turing Tests which have been described herein have been based on the premise that a machine will fail the test by giving the “wrong” answer, whereas a human will pass it by providing the “right” answer. That is, the evaluation of the response in such cases may be assumed to be a simple “yes/no” or “pass/fail” decision. However, in accordance with certain illustrative embodiments of the present invention, it is advantageously possible to distinguish between humans and computers not based simply on whether an answer is right or wrong, but rather, based on the precise nature of errors that are made when the answer is, in fact, wrong.

For example, it has been determined humans, when asked to repeat random digit strings in the presence of loud background white noise, often mistake the digit 2 for the digit 3 and vice versa, but very rarely make other kinds of errors. On the other hand, ASR (Automatic Speech Recognition) systems have been found to make errors of a much more uniform nature (i.e., having a random distribution). Building a classifier system to identify the two cases (i.e., human versus computer) based on error behavior will be straightforward for one of ordinary skill in the art by making use of well known results from the field of pattern recognition. Hence, in accordance with certain illustrative embodiments of the present invention, even when the response to a challenge contains an error, it may very well be possible to distinguish between human error and machine error based on the idiosyncrasies of the two.

The following table provides an illustrative listing of possible approaches to performing a Reverse Turing Test, along with some of their advantages and disadvantages. Note that in some cases, the output and input modalities for a test can be completely different. Also note that several of the example queries are fairly broad, while others (the last two, in particular) require detailed domain knowledge. This could, in fact, be desirable in some cases (e.g., a mailing list established for the exclusive use of experts in a given discipline, such as, for example, American history or musicology). Each of the approaches described above and each of those listed below, as well as numerous other approaches which will be obvious to those skilled in the art, may be used either individually or in combination in accordance with various illustrative embodiments of the present invention.

| Challenge | Response | | |
|---|---|---|---|
| Modality | Modality | Example | Comments |
| Image | Text | What is the word | Exploits difficulty of |
| | | contained in the box | visual pattern recognition. |
| | | (see Figure 2) | Response easy to verify. |
| | | | Requires high resolution. |
| | | | graphical interface. |
| Text | Text | What color is an | Exploits difficulty to |
| | | apple? | natural language |
| | | | understanding. May assume |
| | | | domain knowledge. |
| | | | Response may be difficult |
| | | | to verify. |
| Text | Text | What color is an | Exploits difficulty of |
| | | (a) red (b) blue | natural language |
| | | (c) purple | understanding. Response |
| | | | easy to verify. May |
| | | | be susceptible to guessing |
| | | | attacks. |
| Speech | Text | “Please enter the | Exploits difficulty of |
| | | following digits | speech recognition and |
| | | on your keypad: | natural language |
| | | 1, 5, 2” | understanding. Response |
| | | | easy to verify. Requires |
| | | | telephone-style interface. |
| Speech | Speech | “What number | Exploits difficulty of |
| | | comes after 152?” | speech recongnition and |
| | | | natural lanuage |
| | | | understanding. Response |
| | | | may be difficult to verify. |
| Image | Text | Who is depicted in | Exploits difficulty of |
| | | this image? | image recognition. |
| | | (display image of | Assumes domain |
| | | easily | knowledge. Response may |
| | | recognizable | be difficult to verify. |
| | | person) | Requires hight resolution |
| | | | graphical interface |
| Music | Text | Who composed this | Exploits difficulty of |
| | | music? | musical quotation |
| | | (provide passage | recognition. Assumes |
| | | of easily | domain knowledge. |
| | | recognizable music) | Response may be difficult |
| | | | to verify. |

Overview of an Illustrative E-mail Filtering System

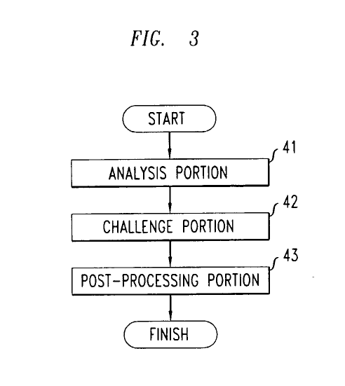

FIG. 3 shows an overview of an e-mail filtering system in accordance with an illustrative embodiment of the present invention. The illustrative system comprises three portions—an analysis portion, shown as block 41, whereby an incoming e-mail is analyzed to determine whether it is desirable to issue a challenge to the sender (i.e., whether it is desirable to perform a Reverse Turing Test); a challenge portion, shown as block 42, whereby a challenge is generated in one of several possible different modalities for issuance to the sender of an incoming e-mail; and a post-processing portion, shown as block 43, whereby a final decision is made regarding the incoming e-mail based on a response or lack thereof to the issued challenge.

Analysis Portion of an Illustrative E-mail Filtering System

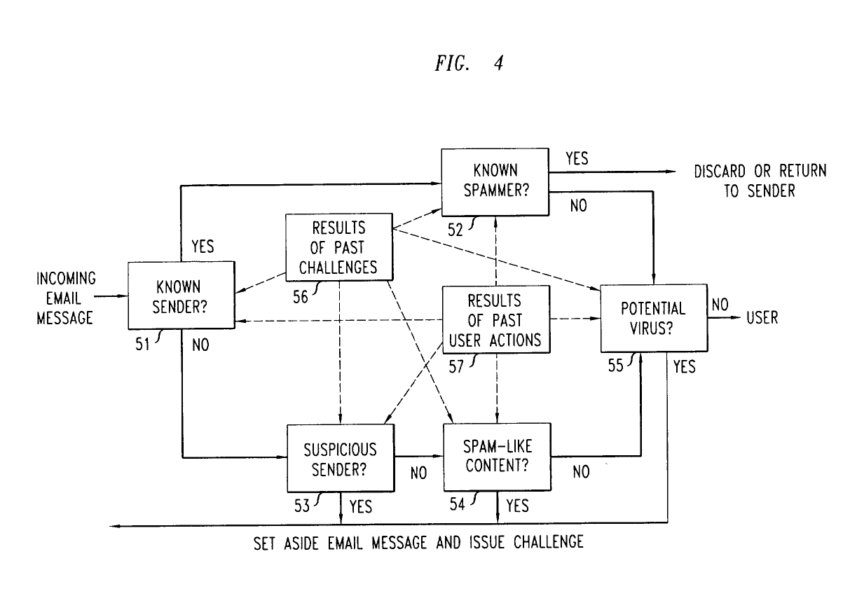

FIG. 4 shows details of the analysis portion of the illustrative e-mail filtering system of FIG. 3, whereby an incoming e-mail is analyzed to determine whether it is desirable to issue a challenge to the sender (i.e., whether it is desirable to perform a Reverse Turing Test). This first portion of the filtering process operates by examining each incoming e-mail message for the likelihood that it may either contain spam or harbor a virus. Note that unlike previously known e-mail filtering systems (or prior suggestions therefor), the illustrative embodiment of the present invention advantageously addresses protection from both e-mail containing viruses as well as from spam e-mail.

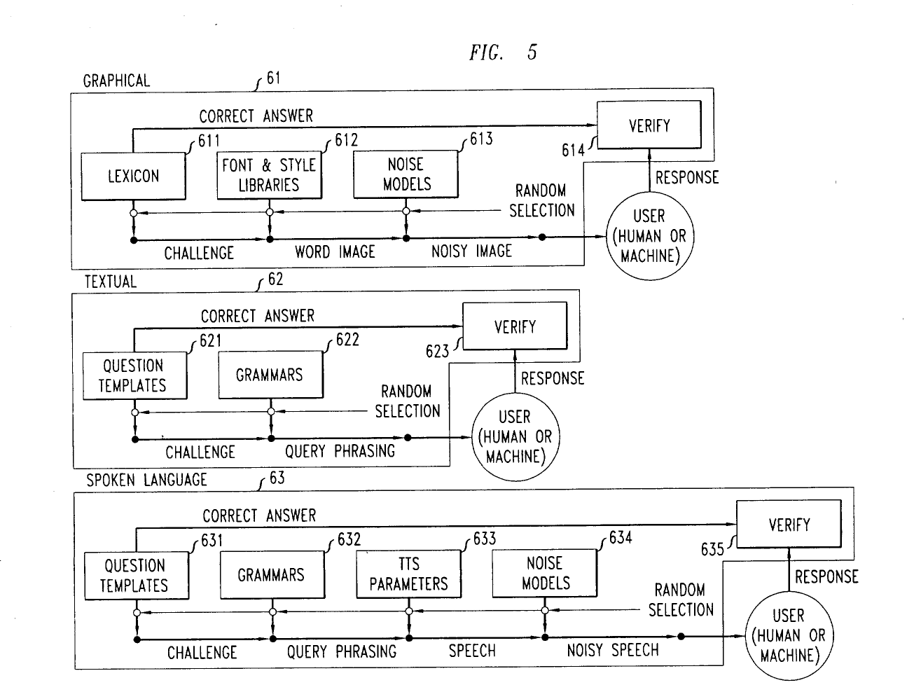

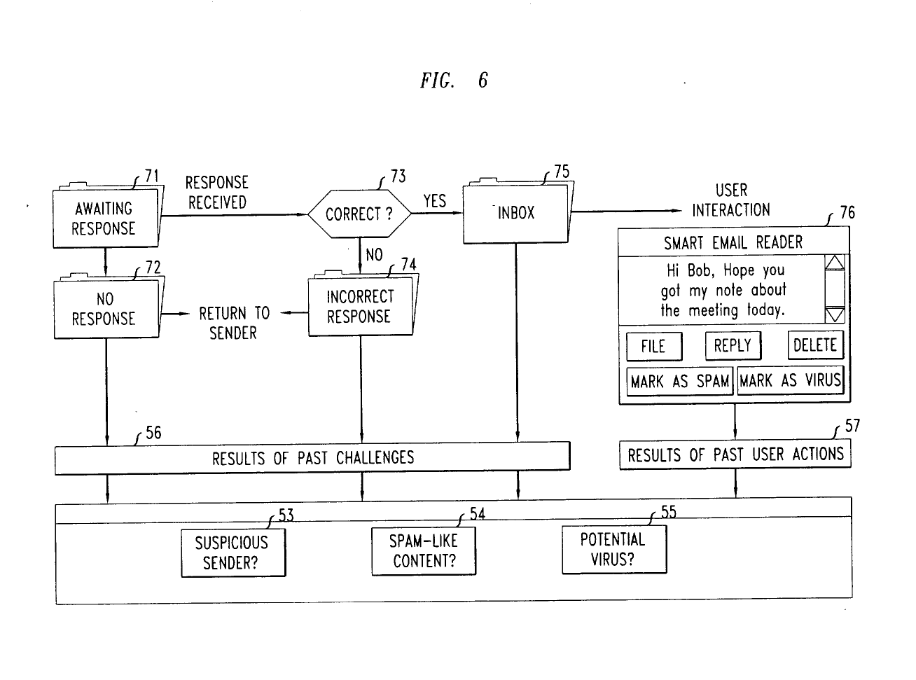

In particular, the analysis portion of the illustrative system as shown in FIG. 4 advantageously performs a variety of analytic tasks to make an initial determination as to whether a given e-mail should be considered either to be a potential virus threat or likely to be spam e-mail. Specifically, the system advantageously first checks to see if the sender is known to be a spammer. If not, the system determines if the message is in any way suspicious (as being either spam or containing a potential virus), making use of both the message header and its content as well as past history (both shared and specific to the intended recipient). In the event a message is deemed suspicious, a challenge will be generated automatically and dispatched back to the sender. (See discussion of FIG. 5 below.) If the sender responds correctly, the message will be forwarded to the user, otherwise it will be either discarded or returned unread. (See discussion of FIG. 6 below.)

Note that the approach of the illustrative e-mail filtering system described herein provides a significant advantage over techniques that do not combine the two paradigms of message content analysis and sender challenges (i.e., Reverse Turing Tests). Without having recourse to a Reverse Turing Test, a system that works only by examining the incoming message must be extremely cautious not to discard valid e-mail. On the other hand, a Reverse Turing Test used by itself (or even in concert with a simplistic mechanism such as a list of acceptable sender addresses) will likely end up generating too many unnecessary challenges, thereby slowing the delivery of e-mail and annoying many innocent senders.

We now consider in turn each of the functional blocks illustratively shown in FIG. 4. First, block 51 checks to see if the (apparent) origin of the message is that of a known sender. More generally, this test advantageously determines whether or not we know anything about the sender and/or the sender's domain—e.g., whether the return address has been seen before, whether the message is in response to a previous outgoing e-mail, whether the timestamp on the message seems plausible given the past behavior of the sender (noting that spam e-mail often arrives at odd hours of the day), etc.

Next, if the e-mail has been categorized as originating from a “known sender,” block 52 then checks to see if the given sender is a known spammer. While it would be relatively easy for a spammer to create a new return address for each mass e-mailing, most spammers are unwilling to make even this small effort at disguising their operations. Thus, if an address is identified as having been the source of spam in the past, it is probably reasonable to discard any future messages originating therefrom. Therefore, in accordance with one illustrative embodiment of the present invention, any messages from such an identified known spammer are either discarded or returned unread to the sender. In accordance with another illustrative embodiment of the present invention, however, a more flexible policy may be adopted in which all such messages are challenged by default.

In accordance with one illustrative embodiment of the present invention, the system could advantageously accept lists of valid (e.g., known safe) or invalid (e.g., known spammer) addresses from a trusted source. For example, in a corporation there are typically designated e-mail accounts that are used to broadcast messages that employees are expected to read. These addresses could be published internally so that such messages are passed through without being challenged.

If, on the other hand, the origin of the e-mail has not been categorized as having come from a “known sender,” block 53 checks to see if it has come from a “suspicious sender.” Note that even if a sender is unknown to the system, it may still be possible to determine that the sender's address and/or ISP (Internet Service Provider) appears suspicious. For example, certain free ISP's are known to be notorious havens for spammers. Therefore, if the e-mail is determined to have originated from an unknown but nonetheless “suspicious” sender, a challenge (i.e., Reverse Turing Test) will be advantageously issued.

Note that e-mail headers contain meta-data that may be advantageously used to determine whether the sender might be classified as a suspicious sender. Some of this data includes, for example, the sender's identity, how the recipient is addressed, the contents of the subject line, and when the message was sent. For example, the “From:” field of a message header raises a warning flag when the address shows evidence of having been created by a machine and not a human—e.g., wv4mkj32ikch09@v87j14ru.org. Similarly, the “To:” field of the message header should normally be the e-mail address of the recipient, a recognizable mailing list, or a legitimate alias used within an organization or workgroup—empty and machine—generated “To:” fields are also suspicious signs. And subject headers of spam e-mail may contain characteristic keywords and/or word associations that can be analyzed through statistical classifiers, fully familiar to those of ordinary skill in the art.

In addition, the timestamp on the message may be indicative of human versus machine behavior. Human activity naturally peaks during “normal” working and/or waking hours, although such observations can also be specialized to the past behavior of specific individuals such as “night owls” (see discussion concerning the use of past history, below). In general, however, mass mailers appear to be more active at night and in the early morning. Moreover, since spam is sent widely and indiscriminately, different people in an organization may all receive the same mailing within a narrow window of time. Taking note of this fact could also be beneficial.

One technique to advantageously deduce which e-mail addresses might be associated with spam is by using an n-gram classifier, fully familiar to those of ordinary skill in the art. Names and initials in a given language typically follow predictable patterns, and therefore, addresses that deviate strongly from the norm could be regarded as suspicious. For instance, f3Dew23s21@ms34.dewlap.com would seem to have a much higher probability of being a spammer than r.tompkins@lucent.com. To confirm this hypothesis, one might, for example, train a trigram classifier on separate databases of spam and desirable e-mail, and then evaluate whether it does a reasonably good job of categorizing addresses it has not yet seen. The advantage such an approach would have over maintaining a simple list is that it could potentially catch (and challenge) new spammers. Building and training such classifiers is a well known technology, fully familiar to those of ordinary skill in the art.

Moreover, users can advantageously arrange to share their n-gram models with friends and colleagues they trust, or the system itself could share them with other trusted systems. One of the defining characteristics of spam is that it is sent to many people, often repetitiously. Thus, if you have a spam message in your mailbox, it is quite possible that someone you know has already received the same e-mail and marked it as such. Likewise, viruses follow a similar distribution pattern. Once someone identifies an incoming virus, copies of the same e-mail on other machines could be advantageously tracked down if n-gram models for message content are shared. (Note that such sharing can take place while preserving user privacy, because what is exchanged is merely the statistical summaries of nearby letters. So long as the basic “quantum” is a block of at least several e-mails, there is no way the receiver of a model can reconstruct the original messages. In the case of addresses, privacy guarantees could be achieved, for example, by grouping 100 at a time.)

Additionally, an e-mail filtering system in accordance with certain illustrative embodiments of the present invention can make advantageous use of the fact that viruses tend to come in clusters by sharing n-gram models. In particular, by sharing n-gram models users can realize that the same (or very similar) messages have been received by many users at nearly the same time. While this alone may not be sufficient evidence to mark e-mails as containing a virus (or being spam), it may advantageously result in those messages being regarded as suspicious.

To implement such a feature in accordance with one illustrative embodiment of the present invention, users could send out degraded n-gram models each time a message was received. The models might be degraded to protect users' privacy by, for example, randomly substituting a fraction F1 of the characters in the message, and/or interchanging a fraction F2 of the characters to a randomly chosen location before calculating the n-gram model. Typically, 0<F1<0.3 and 0<F2<0.1. Note that values of F1 and F2 sufficient to preserve privacy will be larger for short messages (e.g., less than 2000 characters), declining towards zero for very long messages.

The degraded n-gram models could then be advantageously sent to a central model comparison server, which might, for example, compare them for near matches and send out a warning (and an n-gram model) to all users whenever a sufficient number of similar n-gram models have been received in a sufficiently short time. The number and time would be set depending upon the level of security a organization wishes to maintain and the frequency of virus containing and/or spam messages typically received. However, for many organizations, the receipt of 10 similar models within one minute would probably be sufficient to mark a message as “suspicious.” Alternatively, each user could independently operate such a “model comparison server,” and these model comparison servers could advantageously share n-gram models. Note, however, that many organizations generate internal broadcast e-mails, and therefore the above described mechanism would probably be advantageously disabled for e-mails which originated inside the organization, or at least for certain specific sending machines.

Returning to FIG. 4, if the origin of the e-mail is neither known nor suspicious, block 54 advantageously examines the content of the e-mail message for “spam-like content.” While simple keyword spotting is the method most commonly used today to identify such content, more powerful approaches to text categorization have been found to be effective in classifying probable spam as well. (See, e.g., I. Androutsopoulos et al., “An Experimental Comparison of Naive Bayesian and Keyword-based Anti-spam Filtering with Personal E-mail Messages,” Proceedings of the 23rd ACM International Conference on Research and Development in Information Retrieval, pp. 160-167, Athens, Greece, 2000.) Thus, in accordance with various illustrative embodiments of the present invention, any one of various well known techniques for detecting “spam-like content” in an e-mail may be employed to implement block 54 of FIG. 4. Then, if spam-like content is detected, a challenge (i.e., Reverse Turing Test) will be advantageously issued.

More particularly, note that classification of e-mail as possible spam based on message content belongs to the general problem of text categorization. Various known techniques for performing such a classification include the use of hand-written rules—typically by matching keywords—and the building of statistical classifiers based on keywords and word associations. Statistical training typically uses a corpus where individual messages have been labeled as belonging to one class or the other. Since the majority of spam messages tend to be sales-oriented—including prize winning notices, snake oil remedies, and pornography—their word usage tends to be quite different from normal e-mail, and therefore the two classes of messages can be made to be distinguishable.

Classifiers can also be advantageously trained and updated to reflect personal preferences and changes in interests over time. As such, each user's mail folders might reflect his or her preferences when it comes to e-mail classification. In addition, if spam is saved in a special folder rather than being deleted immediately (see discussion below), it may be used as part of a training database where information can be gathered to update statistical classifiers. Since identifying characteristics of individual users are generally obscured when statistical data is amalgamated, it may be possible to share this training data among colleagues at work or friends whose perceptions of “good” versus “bad” e-mail are likely to be similar.

Returning to the discussion of FIG. 4, block 55 analyzes e-mail which has not otherwise been filtered to determine whether it should be deemed to be a “potential virus.” As described above, most current virus detection utilities maintain a list of signatures of known viruses. Thus, in accordance with one illustrative embodiment of the present invention, such a conventional test may be incorporated into the analysis of block 55 of FIG. 4. In accordance with another illustrative embodiment of the present invention, suspicious strings of byte patterns, as described above, may also be used. In either of these cases, the detection of a known virus signature or of a suspicious string of byte patterns advantageously results in a challenge (Reverse Turing Test) to be issued.

In accordance with certain illustrative embodiments of the present invention, machine learning techniques may be advantageously used in an attempt to classify strings of byte patterns as potentially deriving from a virus. In Schultz et al., “Malicious Email Filter—A UNIX Mail Filter that Detects Malicious Windows Executables,” Proceedings of the USENIX Annual Technical Conference—FREENIX Track, Boston, Mass., June 2001, for example, such a filter was found to be 98% effective on a test database consisting of several thousand infected and benign files, a level of performance that far exceeded what was determined to be possible using simple signature analysis (34%). Under such an approach, a message is advantageously assigned a value (between 0 and 1, for example) which indicates the likelihood that it contains a virus. (For example, a value of 0 may indicate “no virus” whereas a value of 1 indicates a “definite virus.”) A value of 0.25, then, would suggest that a given e-mail is “possibly infected, but probably safe.” In accordance with various illustrative embodiments of the present invention, depending on the choice of threshold, such cases may be handled in any of several ways, including, for example, the following:

1. The security policy for a given organization might arbitrarily deem the message to be either “safe” or a “suspected virus.”

2. Specialized software, familiar to those skilled in the art, could be used to search for known viruses, or

3. The system might delay the message, waiting for the results of the challenge to see if the sender is known to be infected. This delay has several additional benefits—it slows the propagation of viruses, and it also allows updated virus-checking software time to catch up to new viruses.

Under the most conservative scenario, however, and in accordance with still another illustrative embodiment of the present invention, a challenge is advantageously issued to the sender whenever a message is found to contain any executable code whatsoever. Note that it is relatively straightforward to recognize the majority of such cases, as executable code typically has a signature near the beginning specifying the language it was written in and its interpreter. Moreover, most programs generated as the result of viruses are identified as executable in a MIME (Multipurpose Internet Mail Extensions) header inside the e-mail. (MIME is a well known specification, fully familiar to those of ordinary skill in the art, for formatting multi-part Internet mail messages including non-textual message bodies.) Such markings are necessary for the virus to propagate—since the virus cannot depend on a human recipient to run it knowingly, it must find a way to be executed either automatically or accidentally. (Somewhat more difficult, however, is the recognition of potential viruses when the e-mail includes attached documents intended for applications that are not primarily programming environments, but which can still execute code under some circumstances. For example, certain word processors have the capability of running code embedded in a document. Nonetheless, most such documents do not contain dangerous code.)

In accordance with the illustrative embodiment of the present invention shown in FIG. 4, block 56 advantageously further incorporates the results of past challenges into the analysis. That is, in addition to pre-programmed criteria such as sender identity and content information, the illustrative e-mail filtering system can be advantageously designed to “learn” from experience. For example, if a sender was challenged in the past and answered correctly (or, alternatively, incorrectly), this information may be used in making decisions about a new message from the same sender. By incorporating such historical information, the system may in many instances be able to avoid issuing a second challenge to a sender, either because the sender has already been “proven” to be human and there is no indication of a possible virus, or because the sender failed a previous challenge and the incoming message also appears suspect.

Keeping track of recent history also provides us with the solution to an apparent conundrum—namely, what is to prevent one instance of a system according to an illustrative embodiment of the present invention from challenging a challenge issued by another instance, thereby leading to an endless cycle? While it is the “goal” of the illustrative embodiments of the present invention to filter out messages that have been sent by machines, it would not do to have our own questions, which are, of course, computer-generated, put in the same category. In accordance with one illustrative embodiment of the present invention, the challenges might be tagged with a conspicuous signature (e.g., “CHALLENGE”), located, for example, in the subject field, in order to explicitly exclude them from such treatment. But this approach for evading the system could be exploited by a spammer. Alternatively, and in accordance with other illustrative embodiments of the present invention, outgoing e-mail is advantageously monitored, hence anticipating potential incoming responses to previously issued challenges, and thereby allowing said responses to bypass the filter.

In accordance with still other illustrative embodiments of the present invention, an Internet standard could be advantageously adopted for tagging challenge e-mails. For example, outgoing challenges might be assigned a cryptographic token in a header field (which may, for example, be advantageously invisible to casual email readers), and challengers may then be expected to return that token when making their own return challenge in response to the original one. Note that if they fail to do so, they might risk an infinite recursion of challenges.

For example, assume that two e-mail users, Alice and Bob, each have e-mail filters, A and B, respectively, in accordance with an illustrative embodiment of the present invention. Also assume that each challenge adds, in accordance with the illustrative embodiment of the present invention, an “X-CHAL: . . .” tag in a header field, which all challenge-response e-mail handlers are requested to pass on in their own challenges. Then, the following sequence of events illustrates an advantageous exchange of e-mail challenges:

1. Alice sends e-mail to Bob; intercepted by B;

2. B challenges Alice (includes an “X-CHAL” header), intercepted by A;

3. A challenges the challenge;

4. B delivers A's challenge to Bob seeing its own signed “X-CHAL” header;

5. Bob responds correctly to A's challenge;

6. A delivers original challenge of B to Alice;

7. Alice responds to B's challenge to challenge; and

8. Bob gets the original e-mail after Alice responds.

Therefore, the general idea here is that challenges advantageously add on an “X-CHAL: . . .” tag which all challenge-response e-mail handlers are expected to pass on in their own challenges. Note that any “X-CHAL” tag can be verified by the originating challenger to avoid the possibility of an infinite recursion. Since it can only come in response to an originated e-mail, it cannot, for example, be abused by spammers. Moreover, challengers that do not implement the standard for passing back “X-CHAL” headers risk causing infinite recursions and destroying their own mail systems.

Returning to FIG. 4, in a similar manner to the incorporation of past history as shown in block 56, and in accordance with the illustrative embodiment of the present invention shown therein, block 57 advantageously further incorporates the results of past user (i.e., the receiver of the e-mail) actions into the analysis. While it has been so far assumed that messages tagged as spam or containing viruses will be discarded without being shown to the user, it may instead be advantageous to file such messages separately for possible later perusal and confirmation of the system's functionality. In this case, actions taken by the user can also be advantageously factored into future decision making. Similarly, if and when a new type of undesirable e-mail makes it through the filter for some reason (e.g., a new genre for spam arises), the user's subsequent actions in marking the message as spam and deleting it manually can be advantageously used to update the filtering criteria. Note that both the history of a user's actions as well as decisions made by the system (e.g., whether a certain message is read or marked as spam and deleted) can be used to update both simple lists and statistical classifiers.

Challenge Portion of an Illustrative E-mail Filtering System

FIG. 5 shows details of the challenge portion of the illustrative e-mail filtering system of FIG. 3, whereby a challenge is generated in one of several possible different modalities for issuance to the sender of an incoming e-mail. Regardless of the modality used, however, it is particularly advantageous that the illustrative e-mail filtering system in accordance with the present invention be able to automatically synthesize a substantial number of tests with easy-to-verify answers. For example, in Coates et al., “Pessimal Print: A Reverse Turing Test,” Proceedings of the Sixth International Conference on Document Analysis and Recognition,” pp. 1154-1158, Seattle, Wash., Sep. 2001, this issue is addressed in the graphical domain through the use of large lexicons, libraries of different looking fonts, and collections of image noise models. In accordance with various illustrative embodiments of the present invention and as illustratively shown in FIG. 5, a number of potential strategies for generating random variation in certain non-graphical domains may also be advantageously employed working from a library of predefined question templates.

Specifically illustrated in the figure are three possible domains—graphical domain 61, textual domain 62, and spoken language domain 63. In graphical domain 61, the approach of Coates et al. is advantageously employed. In particular, a large lexicon (block 611) is used to initially generate a challenge; a library of various different looking fonts and styles (block 612) is used to produce a specific word image; and a noise model is selected from a collection of image noise models (block 613) to produce a noisy image as a challenge to the user (i.e., the sender of the e-mail). Block 614 then verifies the response, thereby advantageously identifying the user as being either human or machine. (See FIG. 6 and the discussion thereof below.)

In the latter two domains—textual domain 62 and spoken language domain 63—question template libraries 621 and 631, respectively, are advantageously used to initially generate a challenge. One example of a template which might be selected from one of these libraries is, illustratively, “What color is ?”, while a specific instance, chosen randomly from among many, might be “an apple.” (Clearly, the correct answer to such a question would be either red or green or golden.) From the basic template, finite state grammars for English (blocks 622 and 632, respectively) can then be advantageously used to render the question in a number of different, but equivalent, forms—“What color is an apple?”, “An apple is what color?,” “What is the color of an apple?,” “Apples are usually what color?,” “The color of an apple is often?”, etc. In this manner, a specific query with a particular query phrasing is advantageously generated. Note that from an analysis standpoint, such grammars play a central role in speech recognition and natural language understanding. For this application, they are advantageously used in a generative mode. By walking a random path from start to finish, variability is advantageously created—variability that humans have no trouble dealing with, but that machines will often not be programmed to handle.

In spoken language domain 63, TTS (text-to-speech) parameters are then applied to the phrased query (block 633) to generate actual speech (i.e., a signal representative of speech). Then audible noise may be advantageously selected from a collection of audible noise models (block 634) to inject into the speech signal, thereby producing noisy speech which will likely make the problem even more difficult for computer adversaries. In either case—textual domain 62 or spoken language domain 63—the textual query or noisy speech query, respectively, is issued as a challenge to the user (i.e., the sender of the e-mail), and block 623 or block 635, respectively, verifies the response, thereby advantageously identifying the user as being either human or machine. (See FIG. 6 and the discussion thereof below.)

In accordance with various illustrative embodiments of the present invention, the wording of the e-mail that conveys the challenge to the sender might vary depending on the situation. For example, if the message is suspected of being spam, the preface to the challenge (Reverse Turing Test) might, for example, be:

Hello. This is Bob Smith's automated e-mail attendant. I received the message you sent to Bob (a copy of which is appended below), but before I forward it to him I need to confirm that it is not part of an unsolicited mass mailing. Please answer the question below to certify that you personally sent this e-mail to Bob. (There is no need to resend the message itself.)

. . . details of challenge . . .

On the other hand, if the e-mail is believed to contain a potential virus, the explanation might be:

Hello. This is Bob Smith's automated e-mail attendant. I received the message you sent to Bob (a copy of which is appended below), but because it appears to contain harmful executable code I need to confirm that it was sent intentionally and not as the result of a computer virus. Please answer the question below to certify that you personally sent this e-mail to Bob. (There is no need to resend the message itself.)

\\. . . details of challenge . . .\\

If you DID NOT send the e-mail in question, please do not answer the question; your system may be infected by a virus responsible for sending the message to Bob. Instead, initiate your standard anti-virus procedure (if necessary, contact your system administrator) and send Bob an e-mail with the subject “VIRUS ALERT” in the header.

Post-processing Portion of an Illustrative E-mail Filtering System

FIG. 6 shows details of the post-processing portion of the illustrative e-mail filtering system of FIG. 3, whereby a final decision is made regarding the incoming e-mail based on a response or lack thereof to the issued challenge. Specifically, and as illustratively shown in block 71, the system sets the message in question aside and waits a predetermined amount of time for a response from the sender. If none is forthcoming, as shown in block 72, the message is either discarded and/or returned. Otherwise, as shown in block 73, the response is checked against the set of correct answers, which the system already knows. (See FIG. 5 and the discussion thereof above, and in particular, verification blocks 614, 623, and 635.)

Note that while it would be advantageous to make the verification task as straightforward as possible, it is often the case that the question may have more than one acceptable (i.e., correct) answer, or that the sender's response will be expressed as a complete sentence which may take one of numerous possible forms. Hence, in accordance with certain illustrative embodiments of the present invention, a liberal (i.e., flexible) definition of what is considered “correct” is advantageously adopted. In particular, it is not necessary to require perfection of the sender, only that the sender demonstrate human intelligence so as to be distinguishable from a machine. So, for example, and in accordance with certain illustrative embodiments of the present invention, spelling and/or typing mistakes are tolerated if the challenge calls for a textual reply. Well known techniques taken from the field of approximate string matching and fully familiar to those of ordinary skill in the art are capable of providing this sort of functionality and may, in accordance with one illustrative embodiment of the present invention, be advantageously employed in block 73 of FIG. 6 (which represents one or more of verification blocks 614, 623, and 635 of FIG. 5).

To facilitate this flexibility, an illustrative system in accordance with various embodiments of the present invention advantageously includes tools for building lenient interpretations of the sought-after response. For example, lists of synonyms might be automatically constructed by looking up words in an on-line thesaurus, and the results might be incorporated into the collection of acceptable answers. Similarly, if the answer is specified as a sentence, a set of satisfactory alternatives might be generated through transformation rules operating on the sentence. Note that it is not necessary that all such rules transform one meaningful sentence into another meaningful sentence. Rather, rules could advantageously transform a given sentence into an intermediate form, which might then be transformed back into a meaningful sentence. A set of such rules, applied in a variety of orders to the original sentence and its transformed versions, could be advantageously used to generate many different but equivalent answers. Such rules and their application will be fully familiar to those of ordinary skill in the art.

Alternatively, and in accordance with other illustrative embodiments of the present invention, answers could be advantageously reduced to a “stem-like” canonical form (perhaps including word or concept ordering), with all potential variability extracted. In such a manner, it would not be necessary to generate or to store large lists of potential responses. Again, such canonical forms and their use will be fully familiar to those of ordinary skill in the art.

In accordance with the illustrative embodiment of the present invention as shown in FIG. 6, if it is determined by block 73 that the response is not correct, then again, the message is either discarded and/or returned (block 74). If, on the other hand, the system judges that the sender has passed the test, the message is presented to the user by placing it into the user's “inbox” (block 75).

As discussed above, an e-mail filtering system in accordance with certain illustrative embodiments of the present invention may advantageously make use of the results of past challenges. (See FIG. 4 and in particular block 56 and the discussion thereof above.) As shown in FIG. 6, the results of “failed” challenges (i.e., those with no response or an incorrect response) may thus be used to update the e-mail filter's classification parameters—that is, this information may be advantageously provided to the analysis portion of the illustrative system described herein by block 56 for use by blocks 53, 54, 55 and 56 as shown in FIG. 4. Moreover, if an e-mail is, in fact, presented to the user (e.g., because the e-mail sender “passed” the challenge), but nonetheless, the user later chooses to identify the e-mail as either spam e-mail or as containing a virus, this feedback can also be included for use in updating the filter's classification parameters. For example, the illustrative user interaction screen 75 shown in FIG. 6 can advantageously provide information to the analysis portion of the illustrative system described herein by block 57, also for use by blocks 53, 54, 55 and 56 as shown in FIG. 4.

In addition, and in accordance with certain illustrative embodiments of the present invention, potential viruses that have been detected automatically (regardless of whether through a “failed” challenge to the sender or otherwise), may be advantageously reported to a system administrator (rather than just being discarded). This might lead to faster responses as new viruses arise, and could also provide a way for certain computers to be marked as infected, so that e-mail originating therefrom might be treated more carefully.

Addendum to the Detailed Description

It should be noted that all of the preceding discussion merely illustrates the general principles of the invention. It will be appreciated that those skilled in the art will be able to devise various other arrangements which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future—i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown. Thus, the blocks shown, for example, in such flowcharts may be understood as potentially representing physical elements, which may, for example, be expressed in the instant claims as means for specifying particular functions such as are described in the flowchart blocks. Moreover, such flowchart blocks may also be understood as representing physical signals or stored physical data, which may, for example, be comprised in such aforementioned computer readable medium such as disc or semiconductor storage devices.

The functions of the various elements shown in the figures, including functional blocks labeled as “processors” or “modules” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof any element expressed as a means for performing a specified function is intended to encompass any way of performing that function including, for example, (a) a combination of circuit elements which performs that function or (b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent (within the meaning of that term as used in 35 U.S.C. 112, paragraph 6) to those explicitly shown and described herein.

We claim:

1. An automated method for filtering electronic mail, the method comprising:
receiving an original electronic mail message from a sender;
identifying the original electronic mail message as being potentially infected with a computer virus; and
automatically sending a challenge back to the sender, wherein the challenge comprises an electronic mail message which requests a response from the sender, and wherein the challenge has been designed to be answered by a person and not by a machine.

2. The method of claim 1 wherein the original electronic mail message is identified as being potentially infected with a computer virus based on the presence of executable code attached thereto.

3. The method of claim 2 wherein the original electronic mail message is identified as being potentially infected with a computer virus further based on an analysis of one or more strings of byte patterns in said executable code.

4. The method of claim 3 wherein the original electronic mail message is identified as being potentially infected with a computer virus further based on the identification of a match between said one or more strings of byte patterns in said executable code with one or more predetermined signatures of known viruses.

5. The method of claim 1 wherein said step of identifying the original electronic mail message as being potentially infected with a computer virus is based in part on results from one or more past challenges that had been sent in connection with previously received incoming electronic mail messages.

6. The method of claim 1 wherein said step of identifying the original electronic mail message as being potentially infected with a computer virus is based in part on a manual analysis of previously received incoming electronic mail messages.

7. The method of claim 1 wherein said challenge comprises an electronic mail message which requests that the sender identify text which is included in a provided image.

8. The method of claim 7 wherein said text included in said image has been degraded with visual noise.

9. The method of claim 1 wherein said challenge comprises an electronic mail message in which said request of said response from said sender is presented to the sender as text.

10. The method of claim 1 wherein said challenge comprises an electronic mail message in which said request of said response from said sender is presented to the sender as speech.

11. The method of claim 10 wherein said speech presented to the sender has been acoustically degraded.

12. The method of claim 1 wherein said challenge comprises an electronic mail message which requests that the sender identify one or more entities included in a provided image.

13. The method of claim 1 wherein said challenge comprises an electronic mail message which requests that the sender identify a characteristic of a provided piece of music presented as audio.

14. The method of claim 1 further comprising the step of filtering out said original electronic mail message when a response to said challenge is not received within a predetermined amount of time.

15. The method of claim 1 wherein said challenge has one or more correct responses associated therewith, the method further comprising the step of filtering out said original electronic mail message when a response to said challenge is received which does not include at least one of said associated correct responses.

16. An automated method for filtering electronic mail, the method comprising receiving a plurality of incoming electronic mail messages;
identifying one or more of said incoming electronic mail messages as being potential spam;
identifying one or more of said incoming electronic mail messages as being potentially infected with a computer virus;
for each of said incoming electronic mail messages which has been identified either as being potential spam or as being potentially infected with a computer virus, automatically sending a challenge back to a corresponding sender of said incoming electronic mail message, wherein each of said challenges comprises an electronic mail message which requests a response from the corresponding sender of said incoming electronic mail message, and wherein each challenge has been designed to be answered by a person and not by a machine.

17. The method of claim 16 wherein said step of identifying one or more of said incoming electronic mail messages as being potential spam comprises, for each of said plurality of incoming electronic mail messages, the steps of:
identifying a corresponding sender of said incoming electronic mail message;
determining whether said corresponding sender matches an entry comprised in a list of known senders;
if said corresponding sender does not match an entry comprised in said list of known senders, determining if said corresponding sender has a suspicious identity; and
identifying said incoming electronic message as being potential spam when said corresponding sender is determined to have a suspicious identity.

18. The method of claim 16 wherein said step of identifying one or more of said incoming electronic mail messages as being potential spam comprises identifying each of said incoming electronic message as being potential spam when said incoming electronic mail message comprises spam-like content.

19. The method of claim 16 wherein said step of identifying one or more of said incoming electronic mail messages as being potential spam is based at least in part on results from one or more past challenges that had been sent in connection with previously received incoming electronic mail messages.

20. The method of claim 16 wherein said step of identifying one or more of said incoming electronic mail messages as being potential spam is based at least in part on a previous manual analysis of previously received incoming electronic mail messages.

21. The method of claim 16 further comprising the step of filtering out each of said incoming electronic mail messages for which a response to the challenge corresponding thereto is not received within a predetermined amount of time.

22. The method of claim 16 wherein each of said challenges has one or more correct responses associated therewith, the method further comprising the step of filtering out each of said incoming electronic mail messages for which a response to the challenge corresponding thereto is received which does not include at least one of said correct responses associated therewith.

23. An automated electronic mail filter comprising:
means for receiving a plurality of incoming electronic mail messages;
means for identifying one or more of said incoming electronic mail messages as being potentially infected with a computer virus;
automatic means for sending challenges back to corresponding senders of each of said incoming electronic mail messages which have been identified as being potentially infected with a computer virus, wherein each of said challenges comprises an electronic mail message which requests a response from the corresponding sender of said incoming electronic mail message, and wherein each challenge has been designed to be answered by a person and not by a machine.

24. The automated electronic mail filter of claim 23 further comprising means for filtering out each of said incoming electronic mail messages for which a response to the challenge corresponding thereto is not received within a predetermined amount of time.

25. The automated electronic mail filter of claim 23 wherein each of said challenges has one or more correct responses associated therewith, the apparatus further comprising means for filtering out each of said incoming electronic mail messages for which a response to the challenge corresponding thereto is received which does not include at least one of said correct responses associated therewith.

26. The automated electronic mail filter of claim 23 further comprising:
means for identifying one or more of said incoming electronic mail messages as being potential spam; and
automatic means for sending challenges back to corresponding senders of each of said incoming electronic mail messages which have been identified as being potential spam, wherein each of said challenges comprises an electronic mail message which requests a response from the corresponding sender of said incoming electronic mail message, and wherein each challenge has been designed to be answered by a person and not by a machine.

27. The automated electronic mail filter of claim 23 wherein said means for identifying one or more of said incoming electronic mail messages as being potential spam comprises:
means for identifying a corresponding sender of each of said incoming electronic mail messages;
means for determining whether each of said corresponding senders matches an entry comprised in a list of known senders;
means for determining if each of said corresponding senders has a suspicious identity when said corresponding sender does not match an entry comprised in said list of known senders; and
means for identifying one or more of said incoming electronic messages as being potential spam when the corresponding sender thereof is determined to have a suspicious identity.

28. The automated electronic mail filter of claim 23 wherein said means for identifying one or more of said incoming electronic mail messages as being potential spam identifies one of said incoming electronic messages as being potential spam when said incoming electronic mail message comprises spam-like content.

29. The automated electronic mail filter of claim 23 wherein said means for identifying one or more of said incoming electronic mail messages as being potential spam is based at least in part on results from one or more past challenges that had been sent in connection with previously received incoming electronic mail messages.

30. The automated electronic mail filter of claim 23 wherein said means for identifying one or more of said incoming electronic mail messages as being potential spam is based at least in part on a previous manual analysis of previously received incoming electronic mail messages.
